(19) United States
(12) Patent Application Publication
(10) Pub. No.: US 2022/0016821 A1
(43) Pub. Date: Jan. 20, 2022

(54) APPARATUS AND METHOD FOR IMPROVING AT LEAST ONE PHYSICAL PROPERTY OF AN EXTRUDED PLASTIC MATERIAL

(71) Applicant: Hans Weber Maschinenfabrik GmbH, Kronach (DE)

(72) Inventor: Johannes Weber, Kronach (DE)

(73) Assignee: Hans Weber Maschinenfabrik GmbH, Kronach (DE)

(21) Appl. No.: 17/373,988

(22) Filed: Jul. 13, 2021

(30) Foreign Application Priority Data
Jul. 15, 2020 (DE) 10 2020 118 667.3

(51) Int. Cl. B29C 48/91; B29C 48/06; B29C 48/88; B29C 48/00

(52) U.S. Cl. CPC B29C 48/91; B29C 48/06; B29K 2105/0032; B29C 48/022; B29C 48/911

(57) ABSTRACT

An apparatus and a method for improving at least one physical property of an extruded plastic material comprise an extruder for extruding the plastic material as well as a laser unit with at least one laser for irradiating the extruded plastic material with laser light. Further, the apparatus has at least one laser light-reflecting reflector arranged at a distance to the extruded plastic material. The laser and the reflector are arranged and designed such that the laser light emitted by the laser is incident on the reflector through the extruded plastic material, the reflector reflects the incident laser light such that at least a part of the reflected laser light hits the extruded plastic material.

### CROSS-REFERENCE TO RELATED APPLICATIONS

This application claims priority to Germany application DE 10 2020 118 667.3, filed Jul. 15, 2020.

### TECHNICAL FIELD

The invention relates to an apparatus and a method for improving at least one physical property of an extruded plastic material. Such an extruded plastic material is, in particular, a polyolefin that is crosslinkable by the supply of energy. The apparatus comprises an extruder for extruding the plastic material.

### BACKGROUND

Extruded polyolefins, such as polyethylene (PE), are crosslinked in the manufacturing process after extrusion to improve their physical properties. Such crosslinking can, in particular, improve the temperature resistance of the extruded polyolefins. In particular, one or more peroxides can be used as crosslinking agents in the polyethylene, which trigger the crosslinking process by increasing the temperature through the supply of energy, especially thermal energy. In particular, radioactive radiation, infrared radiation and hot liquid salt baths are used to supply the necessary energy. The disadvantage of these processes is that handling radioactive radiation requires special precautions and high energy losses occur with infrared radiation and the salt baths, and in the case of salt bath crosslinking the heat input is only via thermal conduction.

Document DE 10 2016 122 985 A1 discloses a method for producing a polymeric profile by means of chemical crosslinking, wherein a plastic profile made of plastic material with added additives is heated with the aid of a laser.

### BRIEF DESCRIPTION

It is the object of the invention to provide an apparatus for improving at least one physical property of an extruded plastic material, in which the introduction of energy into the extruded plastic material is possible in a relatively simple and energy-efficient manner.

This object is solved by an apparatus having the features of claim 1. Advantageous embodiments are specified in the dependent claims.

By an apparatus for improving at least one physical property of an extruded plastic material having the features of claim 1, it is achieved by the laser unit with at least one laser for irradiating the extruded plastic material with laser light that the energy required for influencing the physical property of the extruded plastic material can be easily supplied to the plastic material, wherein the energy losses during the generation of laser light and during the application of the laser light to the extruded plastic material through the reflector are very low and the energy supplied to the extruded plastic material with the aid of the laser light can be applied easily and through the reflector to several areas of the extruded plastic material. Thus, the supplied energy can be easily adjusted depending on the shape and material thickness of the extruded plastic material. Also, the supplied energy can be easily adjusted depending on the feed rate of the extruded plastic material. It is particularly advantageous if the plastic material extruded by the extruder comprises polyethylene or, preferably, peroxides for crosslinking. Generally, the extruded plastic material is made from a plastic material with added additives. The additives decompose by the heat input caused by the laser light to radicals, which cause a chemical crosslinking of the plastic material.

By the apparatus of claim 1, easy crosslinking of the extruded plastic material is accomplished by supplying energy using the laser light so that the then crosslinked extruded plastic material has improved physical properties. In particular, the cross-linked extruded plastic material has increased strength in internal pressure creep tests. This provides the entire cross-section of the extruded plastic material with the energy required to change the physical property.

It is particularly advantageous if the reflector is arranged around the longitudinal axis of the extruded plastic material. This ensures that the laser light reflected by the reflector hits the extruded plastic material again.

Furthermore, it is advantageous if the reflector is arranged such that the extruded plastic material is positioned between the reflecting surface and the laser. This ensures that the laser light and the reflected laser light are safely emitted onto the extruded plastic material.

Furthermore, it is advantageous if the reflector is arranged such that the reflector has an extension in the direction of the longitudinal axis of the extruded plastic material, which is arranged between the extruder and a cooling unit. This enables reliable and low-loss irradiation of the extruded plastic material with laser light.

Furthermore, it is advantageous if the reflector has a concavely curved reflective surface in the direction of the longitudinal axis of the extruded plastic material. This ensures that a large proportion of the reflected laser light remains in the reflector arrangement even after the extruded plastic material has been irradiated through it again and, in particular, strikes the extruded plastic material as reflected laser light very often, preferably at least 100 times to 100000 times in a length section of the extruded plastic material in the range from 1 mm to 10 cm.

Furthermore, it is advantageous if the reflector is cooled by a cooling unit. This prevents excessive heating of the reflector.

Furthermore, it is advantageous if the reflector has at least one arcuate segment. Alternatively, the reflector may comprise several arcuate segments. The arcuate segment or the arcuate segments enclose a portion of the extruded plastic material in an angular range in the range from 190° to 360°. In this case, the segment may be substantially tubular and have a preferably circular opening through which the extruded plastic material is passed. If several segments are provided, the segments can be arranged along a circular path and the extruded plastic material can be guided past the segments within the circular path. This allows a simple and efficient formation of the reflector.

Furthermore, it is advantageous if the reflector has at least one opening through which the laser light emitted by the laser passes onto the extruded plastic material. This enables a simple and compact design of the apparatus. Furthermore, it is hereby easily possible for the laser light to strike the reflector and from the latter to strike the extruded plastic material again.

Furthermore, it is advantageous if the laser or lasers are aligned and arranged such that the center line of the laser light emitted by the laser does not hit the center line of the reflector. It is particularly advantageous if the center line of the laser light emitted by the laser has an angle in the range from 0.1° to 10°, in particular in a range from 1° to 5°, with respect to a course of the center line of the laser light through the center line of the reflector. This ensures that there is no total reflection of the laser light and that the laser light is reflected from the reflector back to the laser.

Alternatively or additionally, it is advantageous if the laser is aligned and arranged such that the center line of the laser light emitted by the laser is not aligned at right angles to the center line of the reflector. It is particularly advantageous if the center line of the laser light emitted by the laser intersects the center line of the reflector at an angle in the range from 80° to 89.9°, in particular in the range from 85° to 89°. This ensures that there is no total reflection of the laser light and that the laser light is not reflected from the reflector back to the laser.

Furthermore, it is advantageous if the laser unit comprises several lasers, wherein the lasers are arranged at uniform intervals, preferably along a circular path, around the longitudinal axis of the extruded plastic material. This allows an easy and efficient supply of laser light to the extruded plastic material as well as through the extruded plastic material to the reflector. This enables efficient energy utilization of the laser light for heating the extruded plastic material.

It is advantageous if the reflector has several openings, wherein the laser light emitted by a laser is incident on the extruded plastic material through one opening each. The number of openings preferably corresponds to the number of lasers used. This allows a simple and space-saving design of the apparatus.

Furthermore, it is advantageous if the plastic material extruded by the extruder comprises laser light-absorbing components. Such laser light-absorbing components are in particular color pigments, such as carbon black. In particular, the extruded plastic material can be a hollow profile, preferably a tube, or a rectangular profile, or a solid profile.

Furthermore, it is advantageous if the laser unit for emitting laser light generates a continuous laser beam. In particular, the laser light can be electromagnetic radiation in the infrared range, in the visible light range and/or in the ultraviolet range. It is particularly advantageous if the laser unit emits light in the range from 900 nm to 1100 nm, in particular in the range from 940 nm to 1060 nm. Here, the laser unit can emit a wavelength spectrum.

It is particularly advantageous if the intensity and/or the amount of laser light emitted per unit of time can be easily adjusted. This makes it easy to supply the extruded plastic material with the energy required for crosslinking, so that energy-efficient irradiation of the extruded plastic material with laser light is possible.

It is particularly advantageous if the laser unit is arranged between the extruder and a cooling unit for cooling the extruded plastic material. This means that the extruded plastic material still has a relatively high temperature, so that the energy to be supplied to the extruded plastic material via the laser light with the aid of the laser unit is lower than for plastic material cooled to room temperature.

Furthermore, it is advantageous if the laser or lasers of the laser unit and the reflector are arranged and designed such that the laser light hits the extruded plastic material in the circumferential direction from all sides.

Further advantages and features result from the following description that explains one embodiment in connection with the enclosed Figure.

### BRIEF DESCRIPTION OF THE DRAWINGS

FIG. 1 shows a schematic illustration of an arrangement with an extruder and post-processing units for producing an extrusion product.

FIG. 2 shows a schematic illustration of a laser unit of the arrangement of FIG. 1 according to a first embodiment.

FIG. 3 shows a sectional view of the laser unit along the cutting line A-A of FIG. 2.

FIG. 4 shows a schematic illustration of a laser unit of the arrangement of FIG. 1 according to a second embodiment.

FIG. 5 shows a sectional view of the laser unit along the cutting line B-B of FIG. 4.

FIG. 6 shows a schematic illustration of a laser unit of the arrangement of FIG. 1 according to a third embodiment.

FIG. 7 shows a sectional view of the laser unit along the cutting line C-C of FIG. 6.

FIG. 8 shows a schematic illustration of a laser unit of the arrangement of FIG. 1 according to a fourth embodiment, and

FIG. 9 shows a sectional illustration of the laser unit along the cutting line D-D of FIG. 8.

### DETAILED DESCRIPTION

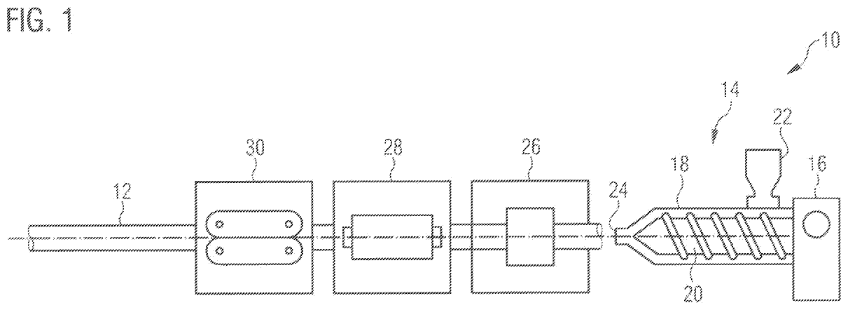

FIG. 1 shows an arrangement 10 for producing an extrusion product 12. The arrangement 10 comprises an extruder 14 having a drive unit 16 for driving one or more extruder screws 20 arranged in a barrel 18. Plastic material in granular or powder form is supplied to the extruder 14 via a feed hopper 22 of the extruder 14 and is melted in the extruder 14 by energy introduced by the extruder screw 20 and supplied heat to form a plastic mass, which is then formed at the extrusion die 24 to form the extrusion product 12. The extrusion product 12 is continuously forced out of the extrusion die 24 during the extrusion process and subsequently passes through a laser unit 26, a cooling section 28 and a take-off unit 30 before the extrusion product 12 can subsequently be separated into sections of a predetermined length. The laser unit 26 irradiates the extrusion product 12, which is still heated by the extrusion process in the extruder 14, with laser light and supplies the extruded plastic material of the wall of the extrusion product 12 with sufficient energy to increase the melt temperature so that at least one physical property of the extrusion product 12 is improved. If polyethylene is used as the plastic material, the temperature resistance of the polyethylene can be improved by crosslinking using peroxides by raising the melt temperature using energy supplied by the laser unit 26. The energy required for crosslinking is supplied to the plastic material by means of the laser light of the laser unit 26. In particular, the extrusion product 12 can be a hollow profile, such as a tube, or a rectangular profile. Alternatively, the extrusion product can also be a solid profile.

Downstream of the laser unit 26, the extrusion product 12 passes through a cooling section 28 for cooling the plastic material and subsequently through the take-off unit 30, which ensures the transport of the extrusion product 12 away from the extruder 14. The finished cooled extrusion product 12 can be further processed downstream of the take-off unit 30, in particular cut into a plurality of sections and deposited in a stack.

The laser unit 26 may comprise one or more lasers. If multiple lasers are provided, they may be spaced at uniform intervals around the longitudinal axis of the extrusion product 12, preferably at equal angular intervals. Additionally or alternatively, the lasers may be spaced apart in the direction of the longitudinal axis.

Compared to conventional thermal post-treatment methods of the extruded plastic material, in particular by means of radioactive radiation, infrared radiation as well as hot liquid salt baths, energy savings can be achieved and large wall thicknesses can be crosslinked by the laser light.

It is particularly advantageous if the laser emits laser light in the range from 800 nm to 1200 nm, in particular 940 nm to 1060 nm, the laser light being monochromatic light, or emits light in the entire spectrum from 800 nm to 1200 nm or from 940 nm to 1060 nm or in a partial range.

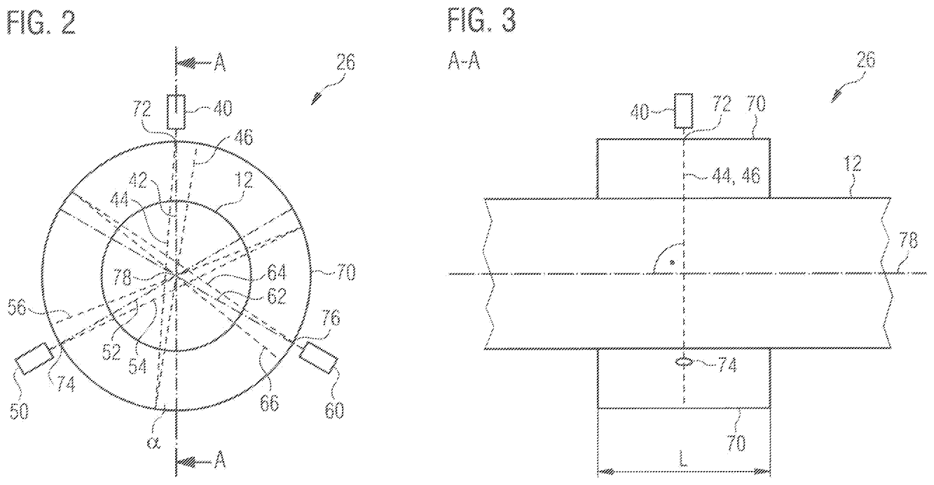

FIG. 2 shows a schematic representation of a first embodiment of the laser unit 26 of the arrangement 10 according to FIG. 1. FIG. 3 shows a sectional view of the laser unit 26 according to FIG. 2 along the cutting line A-A. In the present embodiment, the laser unit 26 has three lasers 40, 50, 60 arranged outside a reflector 70. The center line 78 of the reflector 70 coincides with the longitudinal axis of the extrusion product 12, which is also referred to as extruded plastic material. In other embodiments, the center line 78 of the reflector 70 and the longitudinal axis of the extruded plastic material may be spaced apart and parallel or intersect at an acute angle. In other embodiments, in particular more or fewer lasers 40, 50, 60 may be provided.

The lasers 40, 50, 60 each emit a laser beam 44, 54, 64 that passes through the extrusion product 12 and strikes and is reflected by the reflector 70 so that a reflected laser beam 46, 56, 66 is reflected such that it again passes through the extrusion product 12 and is then repeatedly reflected by the reflector 70 and repeatedly passes through the extrusion product 12. The repeated reflecting of the reflected laser light beam by the reflector 70 and the repeated passing through the extrusion product 12 has not been shown in the figures for clarity.

The lasers 40, 50, 60 are arranged to extend in a plane perpendicular to the center line 78, both the laser beams 44, 54, 64 emitted directly by the lasers and the reflected laser beams 46, 56, 66. The laser beams 44, 54, 64 emitted by the lasers 40, 50, 60 each have an angle a relative to a straight line 42, 62, 52 extending through the exit point of the emitted laser beam at the laser 40, 50, 60 and through the center line 78. Thus, the straight lines 42, 52, 62 intersect the center line 78 orthogonally. The angle a has a value in the range from 0.5° and 20°, in particular in the range between 1° and 10°. It is particularly advantageous if the angle a has a value in the range from 2° to 5°. In the first embodiment, the reflector 70 is closed, in particular tubular and has a length L along the center line 78 or in the transport direction of the extrusion product 12. In other embodiments, the reflector can also be composed of a plurality of segments arranged around the center line 78, preferably on a circular path at the same angular intervals. Preferably, an odd number of segments is provided. It is also advantageous to provide an odd number of lasers, in particular three, five, seven or nine lasers 40, 50, 60. Also, the number of segments of the reflector 70 is preferably three, five, seven or nine. The segments can also have an uneven curvature or be designed as surface elements.

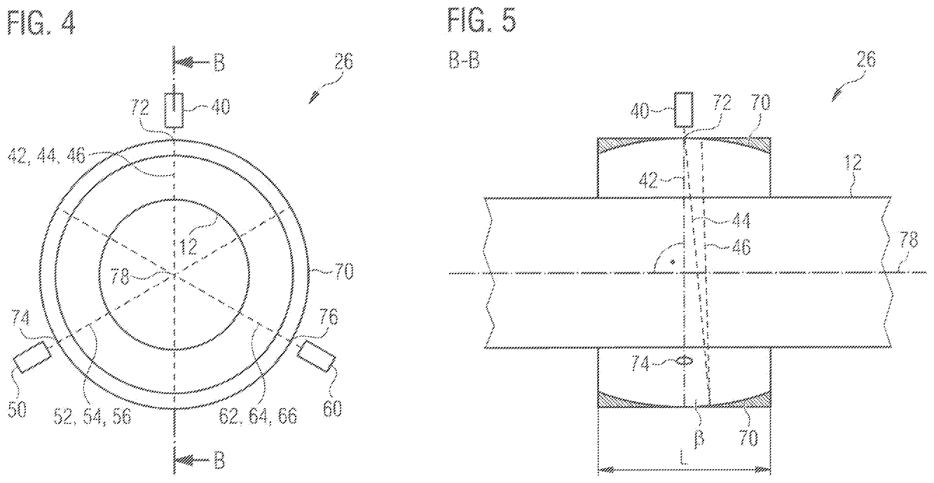

FIG. 4 shows a schematic representation of a second embodiment of the laser unit 26 of the arrangement according to FIG. 1. Elements with the same structure or the same function have the same reference signs. FIG. 5 shows a sectional view of the laser unit 26 according to FIG. 4 along the cutting line B-B.

In contrast to the first embodiment according to FIGS. 2 and 3, the reflector 70 in the second embodiment has a concavely curved reflective surface. The laser units 40, 50, 60 are oriented to intersect the center line 78 of the reflector 70 and have an angle β of a straight line between the exit point of the laser beam 44 and the center line 78 in a plane orthogonal to the center line 78. The curvature of the concave surface of the reflector 70 is selected such that the reflected laser beams 46, 56, 66, including the multiple reflected laser beams, remain in the region of the reflector 70 and penetrate the extrusion product 12 multiple times, preferably 100 to 10,000 times. Preferably, the extrusion product 12 is continuously transported through the laser unit 26.

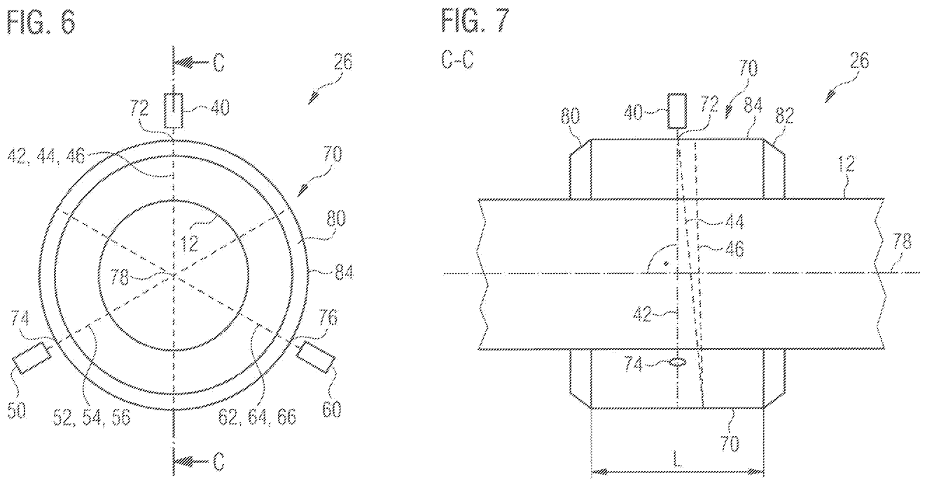

FIG. 6 shows a schematic representation of a laser unit 26 of the arrangement 10 according to FIG. 1 according to a third embodiment. FIG. 7 shows a sectional view of the laser unit 26 according to FIG. 6 along the cutting line C-C. In contrast to the first embodiment according to FIGS. 2 and 3 and the second embodiment according to FIGS. 4 and 5, the reflector 70 has a first cylindrical reflector element 84 which corresponds to the reflector according to the first embodiment and has a first reflector ring 82 at the entrance of the extruded plastic material 12 into the reflector 70 and a second reflector ring 80 at the exit of the extruded plastic material from the reflector 70. The reflective surfaces of the reflector rings 80, 82 are arranged and oriented to reflect light reflected from the reflector element 84 that strikes the reflective surfaces of the reflector rings 80, 82 toward the cylindrical reflector element 84, that is, to reflect the incident laser light toward the cylindrical reflector element 84. In the third embodiment, the reflector rings 80, 82 have oblique reflective surfaces. In other embodiments, the reflector rings 80, 82 may also have curved surfaces that reflect incident light toward the cylindrical reflector element 84. The beam path of the laser light in the third embodiment corresponds to the beam path of the laser light in the second embodiment. In alternative embodiments, a beam path of the laser light according to the first embodiment may also be provided, or a combination of the beam path of the laser light according to the first embodiment and according to the second embodiment may be provided.

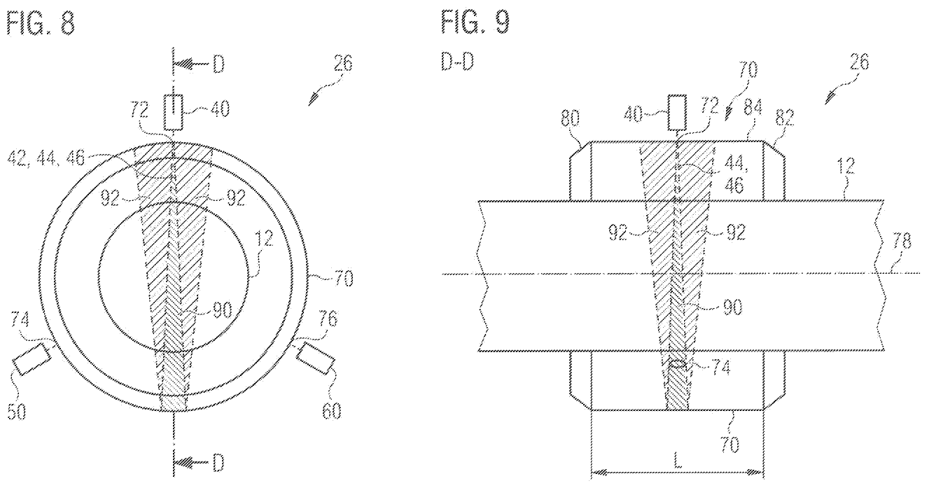

FIG. 8 shows a schematic illustration of a laser unit 26 of the arrangement 10 according to FIG. 1 according to a fourth embodiment. FIG. 9 shows a sectional view of the laser unit 26 according to FIG. 8 along the cutting line D-D. In contrast to the first embodiment, the second embodiment and the third embodiment, in the fourth embodiment according to FIGS. 8 and 9 the laser units 40, 50, 60 comprise at least one optical element for scattering the emitted laser radiation, so that the laser radiation is not emitted as a bundle as in the first three embodiments, but as a beam cone 90. The reflected laser light is shown in FIG. 9 as a beam cone 92. The reflected laser light incident on the reflector element 84 is reflected again by the reflector element 84 and/or by the reflector elements 80, 82, penetrating the extrusion product 12 multiple times, preferably 10 to 10,000 times.

In all four embodiments, the extruded plastic material of the extrusion product 12 may comprise laser light-absorbing components comprising, for example, color particles, in particular carbon black.

Also in the first, second or third embodiments, lasers 40, 50, 60 may be employed, each emitting laser light in a beam cone 90. In the case of laser light in the form of beam cones 90, 92, the center line of the beam cone can also intersect the center line at a right angle, since only a small portion of laser radiation is totally reflected. However, the center line of the beam cone may also coincide with the center line 44, 54, 64 of the emitted laser light beam as shown in the first or second embodiment.

In other embodiments, in the same manner as in the first embodiment, reflectors 70 may be composed of a plurality of segments, preferably an odd number of segments, when the reflective surface is concave. More or less than three lasers 40, 50, 60 may be provided. Furthermore, the lasers 40, 50 and 60 can emit the laser beams as a beam bundle or beam cone such that they have both an angle α to a straight line between the exit point of the laser beam and the center line 78 and an angle β in the direction of the center line 78 of the reflector 70.

What is claimed is:

1. An apparatus for improving at least one physical property of an extruded plastic material, in particular an extruded polyolefin that is crosslinkable by a supply of energy, comprising
an extruder for extruding the plastic material,
a laser unit with at least one laser for irradiating the extruded plastic material with laser light,
at least one laser light-reflecting reflector arranged at a distance to the extruded plastic material,
the laser and the reflector being arranged and designed such that the laser light emitted by the laser is incident on the reflector through the extruded plastic material, and the reflector reflects the incident laser light such that at least a part of the reflected laser light hits the extruded plastic material.

2. The apparatus according to claim 1, characterized in that the reflector is arranged around a longitudinal axis of the extruded plastic material.

3. The apparatus according to claim 1, characterized in that the reflector is arranged such that the extruded plastic material is positioned between the reflecting surface of the reflector and the laser.

4. The apparatus according to claim 2, characterized in that the reflector is arranged in the direction of the longitudinal axis of the extruded plastic material between the extruder and a cooling unit.

5. The apparatus according to claim 1, characterized in that the reflector is designed and arranged such that the reflector has a concavely curved reflective surface in the direction of the longitudinal axis of the extruded plastic material or along the center line of the reflector or that the reflector comprises reflector elements (80, 82) arranged obliquely with respect to the longitudinal axis of the extruded plastic material for reflecting at least a part of the incident laser light onto the extruded plastic material such that at least a part of the laser light exiting again from the extruded plastic material again hits the reflector, wherein preferably a first reflector element is arranged at the entrance of the extruded plastic material into the reflector and a second reflector element is arranged at the exit of the extruded plastic material from the reflector.

6. The apparatus according to claim 1, characterized in that the reflector has at least one arcuate segment or several arcuate segments, wherein the arcuate segment or the arcuate segments enclose a portion of the extruded plastic material in an angular range in the range from 190° to 360°, wherein the one segment is substantially tubular and has a preferably circular opening through which the extruded plastic material is passed or wherein the segments are arranged along a circular path.

7. The apparatus according to claim 1, characterized in that the reflector has at least one opening, the laser light emitted by the laser being incident on the extruded plastic material through the opening.

8. The apparatus according to claim 1, characterized in that the laser is aligned and arranged such that the center line of the laser light emitted by the laser has an angle in the range from 0.1° to 10° with respect to a course of the center line of the laser light through the center line of the reflector.

9. The apparatus according to claim 1, characterized in that the laser is aligned and arranged such that the center line of the laser light emitted by the laser intersects the center line of the reflector at an angle in the range from 80° to 89.9°.

10. The apparatus according to claim 1, characterized in that the laser unit comprises at least 2, 3, 4, 5, 6, 7, 8 or 9 lasers, the lasers being arranged at equal angular intervals, preferably along a circular path, about the longitudinal axis of the extruded plastic material or about the center line of the reflector.

11. The apparatus according to claim 1, characterized in that the extruded plastic material is conveyed past the reflector or through a reflector ring or through several reflector rings.

12. The apparatus according to claim 1, characterized in that the plastic material extruded by the extruder comprises laser light-absorbing components, in particular color pigments, added to the plastic material.

13. The apparatus according to claim 1, characterized in that the plastic material extruded by the extruder is a hollow profile, in particular a tube, or a solid profile.

14. The apparatus according to claim 1, characterized in that the laser for emitting laser light produces a continuous laser beam.
